(19) United States
(12) Patent Application Publication
(10) Pub. No.: US 2015/0337249 A1
(43) Pub. Date: Nov. 26, 2015

(54) Device for Topping Up Alcoholic Beverages in Vessels

(71) Applicant: Wensi Peng, Markham (CA)

(72) Inventor: Wensi Peng, Markham (CA)

(21) Appl. No.: 14/285,619

(22) Filed: May 22, 2014

(51) Int. Cl. C12H 1/22

(52) U.S. Cl. CPC C12H 1/22

(57) ABSTRACT

A device is proposed for reducing head space or ullage in containers being used to age wine or beer. When the device is inserted into a vessel, it will float upright, thus displacing air from the vessel. The device has the added advantage that it does not come into contact with any sediment at the bottom of the vessel. It can easily be removed for cleaning and sanitation.

### BACKGROUND OF THE INVENTION

Topping-up is a critical step in beer and wine making to protect beer or wine against oxidation and spoilage while it is aging. The methods home brewers and winemakers often used are to add cool water, top up with a similar type of wine, or to add marbles. All have limitations. Cool water will dilute the flavor. Similar wine or beer may not always be available. Marbles are too small to easily clean and sanitize.

### SUMMARY OF THE INVENTION

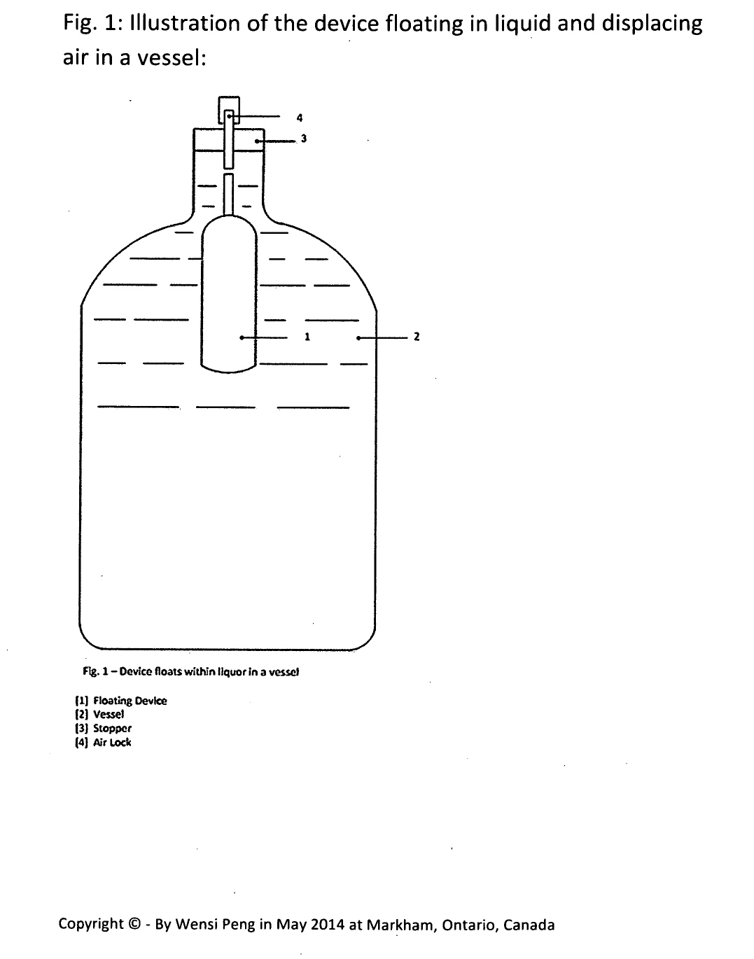

In carrying out this invention, I designed a device that will float upright within liquid. The device displaces air when inserted into a vessel. This method has no negative impact on the quality of the liquid. FIG. 1 illustrates my device floating within liquid and displacing air from a vessel. In FIG. 1, 1 is a floating device, 2 is a vessel, 3 is a stopper and 4 is an air lock.

### DEVICE SPECIFICATIONS

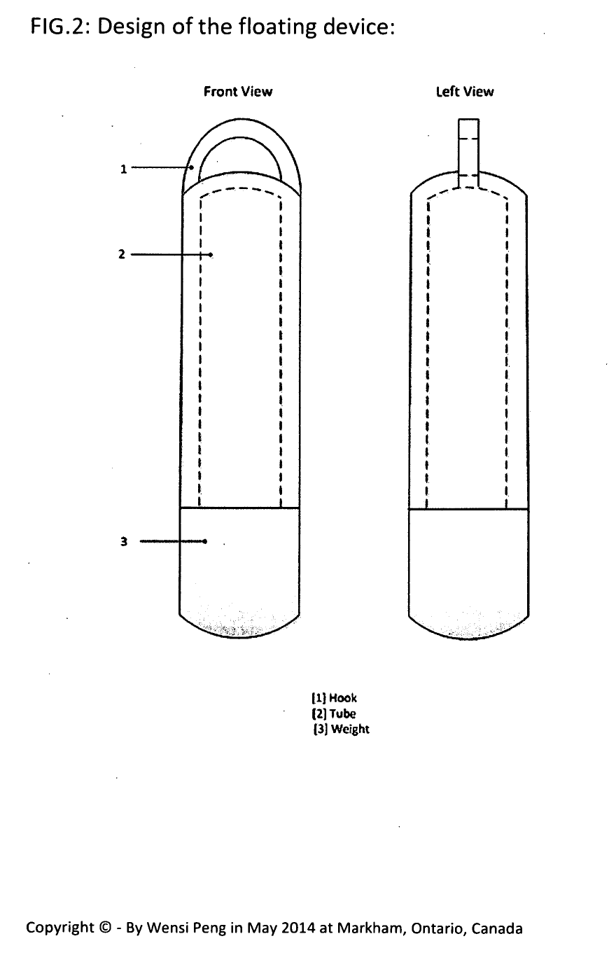

The device is a single unit consisting of a hook at the top, a tube in the middle and a weight at the bottom. The devices can be manufactured in varying diameters and lengths and can be made of food grade material. FIG. 2 is a front plan view and a left plan view. In FIG. 2, 1 is hook, 2 is tube and 3 is weight.

I claim:

1. A floating device for displacing air from vessels in beer and winemaking, said device being a single unit comprising a hook at the top, a tube in the middle and a weight at the bottom.
